(19) United States
(12) Patent Application Publication
(10) Pub. No.: US 2024/0313458 A1
(43) Pub. Date: Sep. 19, 2024

(54) RELIABLE HIGH SPEED CONNECTOR

(71) Applicant: Amphenol East Asia Electronic Technology (Shenzhen) Co., Ltd., Shenzhen (CN)

(72) Inventors: Danren He, Shenzhen (CN); Jingtang Zhou, Shenzhen (CN); Kui Cai, Shenzhen (CN); Yanbin Tan, Shenzhen (CN)

(73) Assignee: Amphenol East Asia Electronic Technology (Shenzhen) Co., Ltd., Shenzhen (CN)

(21) Appl. No.: 18/603,097

(22) Filed: Mar. 12, 2024

Related U.S. Application Data
(63) Continuation of application No. PCT/CN2023/113192, filed on Aug. 15, 2023.

(30) Foreign Application Priority Data
Mar. 13, 2023 (CN) 202320562828.0

(51) Int. Cl. H01R 13/436; H01R 13/502; H01R 13/6581

(52) U.S. Cl. CPC H01R 13/4361; H01R 13/502; H01R 13/6581; H01R 2201/26

(57) ABSTRACT

A modular connector system with components that can be economically assembled to provide reliable high signal integrity in a harsh environment (e.g., automobile). A connector includes a subassembly disposed in a cavity of a housing. The connector has features configured to restrain movements within the subassembly and/or between the subassembly and housing, which would otherwise be problematic due to the harsh environment. The subassembly includes a subassembly housing, a terminal disposed therein, and first and second shields partially stacked. The stacked portion of the first shield includes a stop device protruding toward the subassembly housing through a slot of the second shield, and/or a position limiting device protruding away from the subassembly housing to engage a stop device of the housing. The housing includes a beam with a distal end engaging the first shield. The connector includes a CCPA having a stop device abutting both the first and second shields.

### CROSS-REFERENCE TO RELATED APPLICATIONS

This application is a continuation of International Application No. PCT/CN2023/113192, filed on Aug. 15, 2023, entitled “A CABLE CONNECTOR,” which claims priority to and the benefit of Chinese Patent Application Serial No. 202320562828.0, filed on Mar. 13, 2023, entitled “5G HIGH SPEED CONNECTOR.” The contents of these applications are incorporated herein by reference in their entirety.

### TECHNICAL FIELD

This patent application relates generally to interconnection systems, such as those including electrical connectors, used to interconnect electronic assemblies, and more specifically to electrical connectors for harsh environments, such as in a vehicle.

### BACKGROUND

Electrical connectors are used in many electronic systems. It is generally easier and more cost effective to manufacture a system as separate electronic assemblies, which may be joined together with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted in the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine, transmission (TCUs), security systems, emissions control system, lighting, advanced driver assistance systems (ADAS), entertainment systems, navigation systems, and cameras. These electronic control units may be manufactured as separate assemblies. To simplify manufacture of an automobile, the assemblies may be formed separately and then connected via cables that are terminated with connectors that enable connections to mating board connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those use to communicate data over an automobile network.

### BRIEF SUMMARY

Aspects of the present application relate to connectors configured to provide high speed transmission, especially for harsh environments such as in a vehicle.

Some embodiments relate to an electrical connector. The electrical connector may include a housing comprising a first opening at a mating end, a second opening at a mounting end opposite the mating end, a cavity joining the first opening and the second opening, and a beam having a distal end extending into the cavity; and a terminal subassembly disposed in the cavity of the housing, the terminal subassembly comprising a subassembly housing, at least one terminal disposed in the subassembly housing, and first and second shields partially stacked and disposed outside the subassembly housing, wherein the distal end of the beam of the housing engages the second shield of the terminal subassembly so as to restrain movement of the terminal subassembly toward the second opening of the housing.

Optionally, the electrical connector may include a contact carrier position assurance (CCPA) disposed at a bottom of the housing; and first and second side walls of the housing disposed between a top and the bottom of the housing, wherein the beam extends from one of the first and second side walls of the housing into the cavity of the housing.

Optionally, the one of the first and second side walls of the housing comprises an opening connected to the cavity; and the beam comprises a proximal end connected to an edge of the opening of the one of the first and second side walls.

Optionally, the distal end of the beam is closer to the mating end of the housing than the proximal end of the beam.

Optionally, the one of the first and second side walls of the housing comprises a window disposed closer to the mating end of the housing than the opening; and the contact carrier position assurance (CCPA) comprises a base, and a first arm extending from the base and having a distal latch end engaging the window of the one of the first and second side walls of the housing.

Optionally, the other one of the first and second side walls of the housing comprises window; and the contact carrier position assurance (CCPA) comprises a second arm extending from the base and having a distal latch end engaging the window of the other one of the first and second side walls of the housing.

Optionally, the contact carrier position assurance (CCPA) comprises a stop device extending from the base and protruding into the cavity of the housing through the bottom of the housing; and the stop device of the CCPA abuts against an edge of the first shield of the terminal subassembly.

Optionally, the stop device of the CCPA has a profile conforming to a portion of a boundary of the second shield so as to engage a surface of the second shield.

Some embodiments relate to a terminal subassembly. The terminal subassembly may include a subassembly housing; at least one terminal disposed in the subassembly housing, each of the at least one terminal comprising a mating end, a mounting end opposite the mating end, and an intermediate portion joining the mating end and the mounting end; a first shield disposed outside the subassembly housing and enclosing the mating end of the at least one terminal; and a second shield disposed outside the subassembly housing and enclosing the mounting end of the at least one terminal. The first shield may comprise a mounting portion stacked on a mating portion of the second shield and comprising a stop device. The stop device of the first shield may comprise two proximal ends, and a distal end disposed between the two proximal ends and protruding toward the subassembly housing through a slot of the second shield.

Optionally, the subassembly housing comprises a channel, a terminal of the at least one terminal disposed in the channel, an opening in a mating face into the channel, and a guiding portion tapering toward the mating end of the terminal disposed in the channel.

Optionally, the mating end of the terminal disposed in the channel is shaped as a funnel; and the guiding portion of the subassembly housing overlaps with an opening of the funnel.

Optionally, the terminal subassembly may include a cable attached to the mounting end of the terminal disposed in the channel.

Optionally, the first shield comprises a first sheet with a first edge and a second edge; the first edge is joined to the second edge to at least partially encircle a first cavity with a perimeter bounded by the first sheet; at least a part of the subassembly housing is disposed within the first cavity; and the first sheet comprises the stop device.

Optionally, the mounting portion of the first shield further comprises a position limiting device extending away from the subassembly housing and configured to engage a housing of an electrical connector comprising the terminal subassembly.

Some embodiments relate to an electrical connector. The electrical connector may include a housing comprising a first opening at a mating end, a second opening at a mounting end opposite the mating end, and a cavity joining the first opening and the second opening; a terminal subassembly disposed in the cavity of the housing, the terminal subassembly comprising a subassembly housing, at least one terminal disposed in the subassembly housing, and first and second shields partially stacked and disposed outside the subassembly housing; and a contact carrier position assurance (CCPA) comprising a base disposed at a bottom of the housing, a first arm extending from the base into the cavity to engage the housing, and a stop device extending from the base and protruding into the cavity of the housing to abut both an edge of the first shield and a surface of the second shield of the terminal subassembly.

Optionally, the housing comprises a first side wall having a window; and the first arm comprises a distal latch end engaging the window of the first side wall of the housing.

Optionally, the first side wall of the housing comprises an opening disposed closer to the mounting end than the window; and the housing comprises a beam disposed in the opening of the first side wall and having a proximal end connected to the first side wall and a distal end disposed closer to the mating end than the proximal end.

Optionally, the distal end of the beam of the housing engages the first shield of the terminal subassembly.

Optionally, a stacked portion of the first shield comprises a stop device protruding toward the subassembly housing through a slot of the second shield, and a position limiting device protruding away from the subassembly housing and engaging a stop device extending from a top of the housing.

Optionally, the stop device of the stacked portion of the first shield is on a same side as where the stop device of the CCPA abuts the edge of the first shield and the surface of the second shield.

Some embodiments relate to an electrical connector. The electrical connector may be a 5G high speed connector. The electrical connector may comprise an insulative housing shaped to have a hollow cylinder extending in a longitudinal direction and having open mounting end and mating end; and a terminal subassembly which may be disposed in a cavity inside the insulative housing. The terminal subassembly may comprise a subassembly, a first shield, and a second shield fixedly disposed outside the subassembly. A mounting portion of the first shield may be fixedly disposed outside a mating portion of the second shield, and mechanically and electrically connected with the mating portion of the second shield. The terminal subassembly may be inserted into the insulative housing from the mounting end of the insulative housing. A position limiting device may be provided on the terminal subassembly. A stop device engaging the position limiting device may be provided in the cavity of the insulative housing. The stop device may engage the position limiting device of the terminal subassembly inserted into the insulative housing. The terminal subassembly may be fixedly disposed in the insulative housing in a detachable manner.

Some embodiments relate to an electrical connector. The electrical connector may include an insulative housing and a terminal subassembly disposed in the insulative housing. The terminal subassembly may comprise a first shield and a second shield partially disposed in the first shield in a fixed manner. The terminal subassembly may be further provided therecon with a position limiting device. A stop device configured to engage the position limiting device may be provided in the insulative housing. In this way, the relative movement of the terminal subassembly in the insulative housing may be reduced/prevented by engagement between the stop device in the insulative housing and the position limiting device on the terminal subassembly, so that the terminal subassembly is fixedly disposed in the insulative housing in a detachable manner. Such a configuration can enable the electrical connector of the present disclosure to have improved structure stability and reduced risks of loosening/unmating from a mating component due to vibration, thus providing a more consistent signal path.

Optionally, the stop device may be provided on a side wall of the insulative housing and configured as a beam extending in a longitudinal direction and overhanging at a mating end. A first stop member extending into a cavity inside the insulative housing may be provided at a distal end of the beam, and the first stop member may abut against the second shield of the terminal subassembly inserted into the insulative housing.

Optionally, the beam may exert a biasing force towards interior of the insulative housing via the first stop member to the second shield of the terminal subassembly.

Optionally, the stop device may comprise an engaging portion provided on an inner wall of the insulative housing and protruding towards the cavity inside the insulative housing. The first shield may comprise a first shield position limiting device protruding from an outer surface of the first shield in a direction away from the terminal subassembly. The engaging portion may abut against the first shield position limiting device on the first shield of the terminal subassembly inserted into the insulative housing and engage a distal end of the first shield position limiting device.

Optionally, the first shield may be a hollow cylinder enclosed by a first sheet, and the first shield position limiting device may be formed as a projection extending radially outward in a direction orthogonal to the outer surface of the first sheet.

Optionally, a proximal end surface of the engaging portion on the inner wall of the insulative housing may contact a distal end surface of the projection formed on the first shield in the longitudinal direction.

Optionally, the electrical connector may further comprise a contact carrier position assurance (CCPA) which may be inserted into the insulative housing in a direction perpendicular to the longitudinal direction from outside of the insulative housing and positioned between the terminal subassembly and the insulative housing. The contact carrier position assurance (CCPA) may comprise a stop device. The stop device of the contact carrier position assurance (CCPA) may extend into a cavity inside the insulative housing in a direction perpendicular to the longitudinal direction and engage the mounting end of the first shield of the terminal subassembly inserted into the insulative housing in the longitudinal direction.

Optionally, the contact carrier position assurance (CCPA) may comprise: a base extending in the longitudinal direction; and two arms extending from the base, the two arms being provided near a mating end of the base and on two opposite sides of the base in a transverse direction perpendicular to the longitudinal direction respectively, and the two arms extending in a vertical direction perpendicular to the longitudinal direction and the transverse direction. The stop device of the contact carrier position assurance (CCPA) may be provided at a mounting end of the base and extend in the vertical direction.

Optionally, the arm may have a hooked latch at an end away from the base. Windows may be disposed on two opposite side walls of the insulative housing in a direction perpendicular to the longitudinal direction, and configured to receive the hooked latch of the arms of the contact carrier position assurance (CCPA).

Optionally, a beam extending in the longitudinal direction and overhanging at the mating end may be further formed on one of the two side walls of the insulative housing formed with the windows. A first stop member extending into a cavity inside the insulative housing may be provided at a distal end of the beam, and the first stop member may abut against the second shield of the terminal subassembly inserted into the insulative housing.

Optionally, the first shield may further comprise a stop device formed on an inner surface of the first sheet, the stop device may be disposed in a stacked area of the first shield and the second shield. The stop device of the first shield may extend towards a first cavity in a direction orthogonal to the inner surface of the first sheet. The second shield may comprise a first slot receiving the stop device of the first shield. Engagement of the stop device of the first shield with the first slot may secure the first shield to the second shield.

Optionally, the second shield may have an oval cross section in the stacked area. The oval cross section may comprise a first straight portion and a second straight portion. A first curved portion and a second curved portion joined by the first straight portion and the second straight portion. The second shield may comprise convexities extending radially outward from the first curved portion and the second curved portion respectively and extending circumferentially in the stacked area.

Optionally, the convexity of the second shield may engage an inner surface of the first shield to electrically connect the first shield to the second shield.

Optionally, the first slot of the second shield may be provided in the first straight portion of the second shield.

Optionally, the first shield may further comprise a second stop device, and wherein the second shield may further comprise a second slot parallel to the first slot, and wherein an end portion of the second stop device extends through the second slot.

Optionally, a subassembly may include a cable, a terminal connected with the cable, and an assembly housing to accommodate the terminal. The terminal may be inserted into the assembly housing, and the assembly housing is inserted into the second shield from the mounting end of the second shield and partially inserted into the first cavity such that the mating end of the terminal is visible via an opening at the mating end of the assembly housing, an opening at the mating end of the first shield, and an opening at the mating end of the insulative housing.

Optionally, the terminal may include a hollow cylindrical portion which is located at the mating end, and which extends in the longitudinal direction. A receiving portion to communicate with the opening of the assembly housing may be configured at the mating end of the hollow cylindrical portion, and the receiving portion may include a tapering portion that tapers in the longitudinal direction from the mating end of the hollow cylindrical portion toward a proximal side of the hollow cylindrical portion.

Optionally, the terminal may include a hollow cylindrical portion which is located at the mating end, and extends in the longitudinal direction. A receiving portion to communicate with the opening of the assembly housing may be configured at the mating end of the hollow cylindrical portion, and the receiving portion may include a large-diameter opening located at the mating end of the hollow cylindrical portion, a tapering portion that tapers in the longitudinal direction from the large-diameter opening toward the proximal side of the hollow cylindrical portion, and a small-diameter opening adjacent to the tapering portion, the small-diameter opening having a size smaller than that of the body of the hollow cylindrical portion in a transverse cross-section perpendicular to the longitudinal direction of the electrical connector.

Optionally, the opening of the assembly housing may include a guiding portion which is in communication with an internal cavity of the assembly housing for accommodating the terminal and in communication with the receiving portion. The guiding portion may be shaped such that: in the transverse cross-section perpendicular to the longitudinal direction, at least a portion of the guiding portion has a size smaller than that of the mating end of the hollow cylindrical portion.

Optionally, the guiding portion may include a first portion tapering in the longitudinal direction from the mating end of the assembly housing toward the side of the receiving portion and a second portion extending in a straight line from the first portion along the longitudinal direction. The second portion is in communication with the internal cavity of the assembly housing for accommodating the terminal, and the second portion has a size smaller than that of the mating end of the hollow cylindrical portion in the transverse cross-section perpendicular to the longitudinal direction.

Optionally, the first portion of the guiding portion may be shaped in a funnel shape and may include a large-diameter portion located at the mating end of the assembly housing, a small-diameter portion adjacent to the second portion, and an inclined portion that extends taperingly between the large-diameter portion and the small-diameter portion.

Optionally, the guiding portion may be formed in an hourglass shape. The second portion is provided in the longitudinal direction at an intermediate position between the mating end of the assembly housing and the internal cavity for accommodating the terminal. An expansion portion is provided between the second portion and the internal cavity, and the expansion portion has a size smaller than that of the mating end of the hollow cylindrical portion in the transverse cross-section perpendicular to the longitudinal direction.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electrical connector, according to some embodiments;

FIG. 2 is a partially exploded perspective view of the electrical connector of FIG. 1, according to some embodiments;

FIG. 3 is a side view of the electrical connector of FIG. 1, according to some embodiments;

FIG. 4 is a cross-sectional view of the electrical connector of FIG. 1 taken along a line marked “A-A” in FIG. 3, according to some embodiments;

FIG. 5 is a front view of the electrical connector of FIG. 1, according to some embodiments;

FIG. 6 is a cross-sectional view of the electrical connector of FIG. 1 taken along a line marked “B-B” in FIG. 5, according to some embodiments;

FIG. 7 is an exploded perspective view of a terminal subassembly of the electrical connector of FIG. 1, according to some embodiments;

FIG. 8 is a partial cross-sectional view of the terminal subassembly of FIG. 7, according to some embodiments;

FIG. 9 illustrates a side view of the terminal subassembly of FIG. 7, according to some embodiments;

FIG. 10 is a cross-sectional view of the terminal subassembly of FIG. 7 taken along a line marked “C-C” in FIG. 9;

FIG. 11 is a side view of a second shield of the terminal subassembly of FIG. 7, according to some embodiments;

FIG. 12 is a cross-sectional view of the second shield of FIG. 11 taken along a line marked “D-D” in FIG. 11, according to some embodiments;

FIG. 13 is a side view of a contact carrier position assurance (CCPA) of the electrical connector of FIG. 1, according to some embodiments;

FIG. 14 is a side view of the electrical connector of FIG. 1, according to some embodiments; and

FIG. 15 is a front view of the electrical connector of FIG. 1, according to some embodiments.

### DETAILED DESCRIPTION

The inventors have recognized and appreciated techniques for making a connector for providing high data rate transmission that may be economically manufactured yet operate reliably in the harsh environment presented by an automobile. Such a connector would be suitable for interconnecting assemblies in an automotive network, for example.

An electrical connector may include a housing having a cavity and a terminal subassembly disposed in the cavity of the housing. The connector may have features configured to restrain relative movements within the terminal subassembly and/or between the terminal subassembly and the housing, which might otherwise cause problems due to the harsh environment.

In some embodiments, the terminal subassembly may include a subassembly housing, a terminal disposed in the subassembly housing, and first and second shields partially stacked. The stacked portion of the first shield may include a stop device protruding toward the subassembly housing through a slot of the second shield, which may reduce the risk of relative movements between the subassembly housing holding the terminal and the first and second shields. The stacked portion of the first shield may include a position limiting device protruding away from the subassembly housing and toward a top of the connector housing to engage a stop device extending from the top of the connector housing into the cavity, which may reduce the risk of relative movements between the terminal subassembly and the housing of the connector, for example, in a top-to-bottom direction.

In some embodiments, a side wall of the housing may have an opening and a beam disposed in the opening. The beam may have a proximal end connected to the side wall and a distal end protruding into the cavity and engaging the first shield, which may reduce the risk of relative movements between the terminal subassembly and the housing of the connector, for example, in a left-to-right direction.

In some embodiments, the connector may include a connector position assurance (CPA) at a top and configured to engage a mating connector to ensure reliable connector between the connector and the mating connector. The connector may include a contact carrier position assurance (CCPA) at a bottom. The CCPA may include a base, and one or more arms extending from the base to engage windows on the side walls of the connector housing at locations closer to a mating end of the housing than the beam, which may reduce the risk of relative movements between the terminal subassembly and the housing of the connector, for example, in a left-to-right direction. The CCPA may have a stop device extending from the base and abutting both the first and second shields. The stop device of the CCPA may have a profile conforming to a boundary of the second shield such that it contacts the boundary of the second shield. The edge of the profile of the stop device may engage an edge of the first shield, which may reduce the risk of relative movements between the terminal subassembly and the housing of the connector, for example, in a front-to-back direction.

In some embodiments, the housing of the connector may include a guiding portion at the mating end and configured to guide the insertion of a mating terminal of a mating connector so as to reduce the risks of damaging the terminal of the electrical connector.

These techniques may be used singly or in combination. These techniques are illustrated below in connection with an interconnection system that may be used, for example, to make physical connections between assemblies in an automobile.

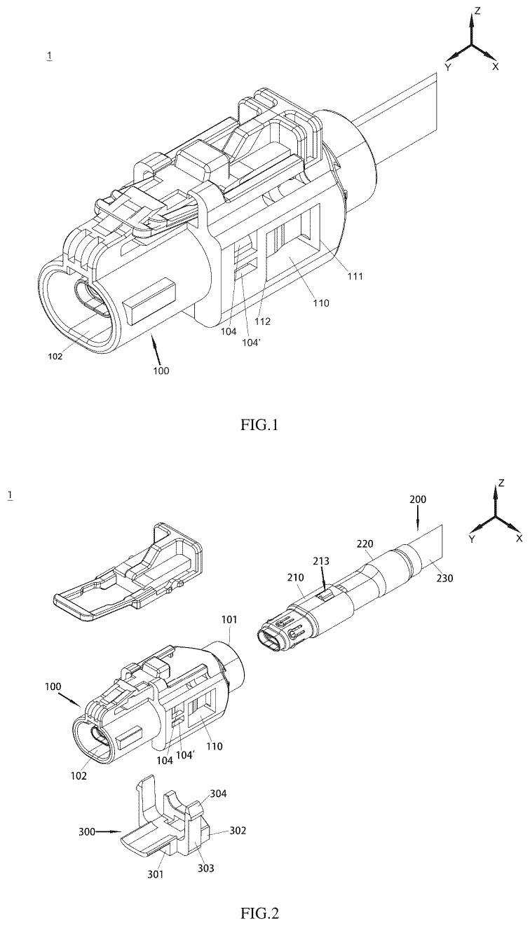

Referring to FIGS. 1 and 2, FIG. 1 illustrates a perspective view of an electrical connector 1 according to some embodiments, and FIG. 2 illustrates a partially exploded view of the electrical connector 1 of FIG. 1.

In the illustrated exemplary embodiment, the electrical connector 1 may comprise an insulative housing 100 and a terminal subassembly 200 inserted into the insulative housing 100 and fixed in the insulative housing 100 in a detachable manner.

In some embodiments, the insulative housing 100 may include a hollow cylinder. The insulative housing 100 may extend in a longitudinal direction (e.g., y-direction as illustrated in the figures) and have a mounting end 101 and mating end 102. As illustrated, the insulative housing 100 may have an opening formed at the mounting end 101 and an opening formed at the mating end 102.

In some embodiments, the “mounting end” and the “mating end” of the insulative housing 100 of the electrical connector 1 may refer to the two opposite ends of the insulative housing 100 in an inserting direction (e.g., y-direction illustrated in the figures), respectively. Optionally, in the illustrated example, with reference to FIGS. 1 and 2, the “mounting end” of the insulative housing 100 may refer to an end of the insulative housing 100 in which the terminal subassembly 200 is inserted, e.g., the end indicated by reference sign “101”, while the “mating end” of the insulative housing 100 may refer to an end of the insulative housing 100 opposite to the mounting end 101 in the inserting direction, e.g., the end indicated by reference sign “102”. The present disclosure may refer to “mounting end” and the “mating end” of other portions of the electrical connector in a manner substantially similar to that of the insulative housing 100.

In some embodiments, the terminal subassembly of the electrical connector is configured to be inserted into the insulative housing from the mounting end of the insulative housing and is fixedly disposed in the insulative housing in a detachable manner. The mating end of the insulative housing may be configured to engage a mating component, for example, a mating board connector (not shown).

As shown in FIG. 2, the terminal subassembly 200 of the electrical connector 1 may be inserted into the insulative housing 100 at the mounting end 101 of the insulative housing 100 in the longitudinal direction (e.g., y-direction) of the insulative housing 100 and disposed in a cavity enclosed by the hollow cylinder of the insulative housing 100. In some embodiments, the terminal subassembly 200 may be fit in the insulative housing 100 in a detachable manner. For example, the terminal subassembly 200 may be detached from the insulative housing 100 for repair or replacement.

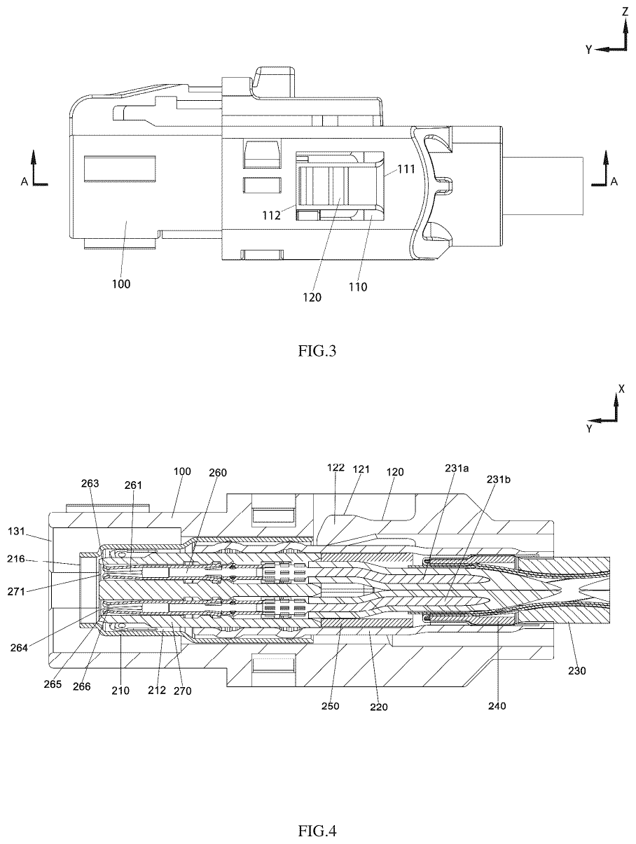

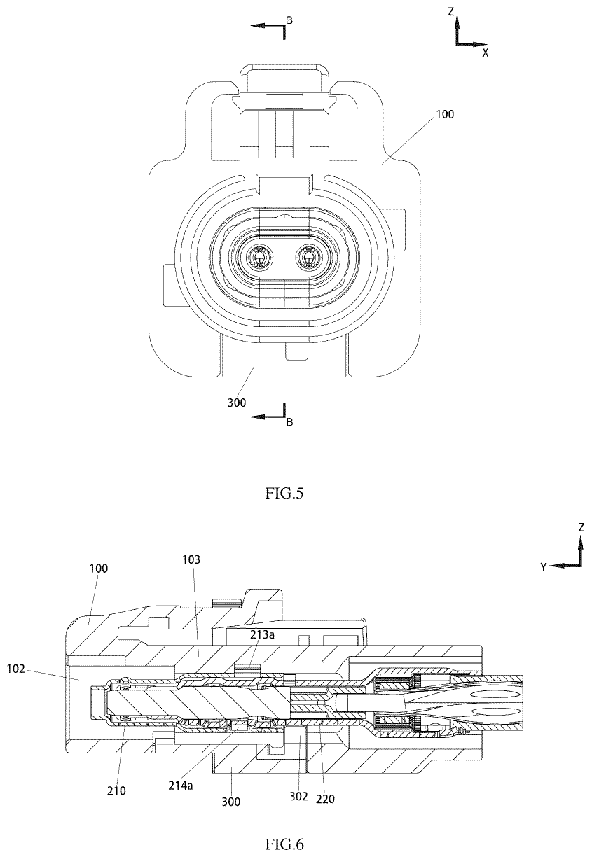

Referring to FIGS. 3 to 7, the terminal subassembly 200 of the electrical connector 1 may comprise a subassembly 205 and a first shield 210 and a second shield 220 fixedly disposed outside the subassembly 205. The first shield 210 and the second shield 220 may be mechanically and electrically coupled together.

As shown in FIG. 6, the first shield 210 of the terminal subassembly 200 may be provided adjacent to the mating end 102 of the insulative housing 100. The second shield 220 of the terminal subassembly 200 may be provided adjacent to the mounting end 101 of the insulative housing 100. The second shield 220 may be fixedly disposed and attached to outside of the subassembly 205. In some embodiments, a mounting portion of the first shield 210 may be fixedly disposed outside a mating portion of the second shield 220, and mechanically and electrically connected with the mating portion of the second shield 220. The mounting portion of the first shield 210 may be stacked with the mating portion of the second shield 220.

In some embodiments, the subassembly 205 may include a cable 230, a terminal 260 connected with the cable 230, and an assembly housing 270 to accommodate the terminal 260. As shown in FIG. 4, the terminal 260 may be inserted into the assembly housing 270. The assembly housing 270 may be inserted into the second shield 220 from a mounting end of the second shield 220 and partially into the first cavity 212, such that at least a portion of the terminal 260 of the subassembly 205 extends beyond the mating end of the second shield 220 and is disposed within the mating portion of the first shield 210. The mating end of the terminal 260 is exposed via an opening 271 at a mating end of the assembly housing 270, an opening 216 at a mating end of the first shield 210 and an opening 131 at a mating end 102 of the insulative housing 100 so that it can engage a mating component (not shown).

In some embodiments, a position limiting device may be provided on the terminal subassembly, and a stop device may be provided in the cavity inside the insulative housing, the stop device engages the position limiting device on the terminal subassembly inserted into the insulative housing, so that the terminal subassembly may be fixedly disposed in the insulative housing in a detachable manner.

In some embodiments, an opening 110 may be provided on one side wall of the insulative housing 100, and the opening 110 may be provided therein with a beam 120 extending from the mounting end 111 of the opening 110 towards the mating end 112 of the opening 110 in the longitudinal direction, as shown in FIG. 3. The beam 120 comprises a distal end 121 and a first stop member 122 provided on the distal end 121. The first stop member 122 may be a protrusion extending at the distal end 121 towards the cavity inside the insulative housing 100. As shown in FIG. 4, when the terminal subassembly 200 is inserted into the insulative housing 100, the first stop member 122 engages the second shield 220 of the terminal subassembly 200 and abuts against the outer surface of the second shield 220.

Referring to FIG. 4, the terminal subassembly 200 may latch to the insulative housing 100 by the first stop member 122 of the beam 120. Optionally, the beam 120 may be configured as an elastically deformable member, and the first stop member 122 of the beam 120 may have a cam-shaped surface. When the terminal subassembly 200 is inserted into the insulative housing 100, the second shield 220 may engage the first stop member 122, and in this engagement position, the elastic force of the beam 120 itself will push the beam 120 to shift in the downward direction of FIG. 4, thereby latching the second shield 220 in a direction perpendicular to the longitudinal direction of the insulative housing 100.

In this way, the beam 120, as a stop device provided in the cavity of the insulative housing 100, exerts a biasing force towards the interior of the insulative housing 100 via the first stop member 122 to the second shield 220 of the terminal subassembly 200 by its own elastic deformation, thereby exerting a biasing force to the second shield 220 in the transverse direction perpendicular to the longitudinal direction (as shown in the figure in the x direction). Under the effect of this biasing force in the transverse direction, the terminal subassembly 200 is prevented from creating relative movement in the insulative housing 100 in the transverse direction, resulting in a more stable structure of the electrical connector.

In some embodiments, by using an elastically deformable beam 120 provided on the side wall of the insulative housing 100, the first stop member 122 is formed integrally with the insulative housing 100, simplifying the stop structure while reducing the time for installing the electrical connector. Such a configuration can reduce the manufacturing cost. It should be understood that the structure of the first stop member 122 is not limited thereto. Optionally, an elastic member, such as a spring, may be provided between the side wall of the insulative housing 100 and the terminal subassembly 200 to exert an elastic effect on the terminal subassembly 200 so as to prevent the terminal subassembly 200 moving in the transverse direction. Optionally, the electrical connector 1 may further be provided with various biasing members, as long as the biasing members may pass through the opening 110 of the insulative housing 100 and bias the terminal subassembly 200 towards the interior of the insulative housing 100.

In some embodiments, the stop device provided in the cavity of the insulative housing 100 may comprise an engaging portion 103 provided on the inner wall of the insulative housing 100. The stop device 103 may protrude towards the cavity inside the insulative housing 100, as shown in FIG. 6. In the illustrated exemplary embodiment, the first shield 210 may comprise a first shield position limiting device 213 protruding outward from an outer surface of the first shield 210 in a direction away from the terminal subassembly 200 disposed in the first shield 210. When the terminal subassembly 200 is inserted into the insulative housing 100 in the longitudinal direction, the engaging portion 103 on the insulative housing 100 abuts against the first shield position limiting device 213 provided on the first shield 210, and the engaging portion 103 engages the distal end of the first shield position limiting device 213.

In some embodiments, the first shield 210 may include a hollow cylinder enclosed by a first sheet 211. The first shield position limiting device 213 may be formed as a projection 213a extending in a radially outward direction of the hollow cylinder in a direction orthogonal to the outer surface of the first sheet 211.

Optionally, the proximal end surface of the engaging portion 103 provided on the inner wall of the insulative housing 100 contact a distal end surface of the projection 213a formed on the first shield 210 in the longitudinal direction of the electrical connector 1.

Optionally, the engaging portion 103 is provided on a side wall adjacent to the side wall formed with the opening 110 and the beam 120, in a circumferential direction of the insulative housing 100.

In this manner, engagement of the engaging portion 103 provided on the inner wall of the insulative housing 100 with the first shield position limiting device 213 of the first shield 210 provides a stop function that can reduce the risk of relative movement of the first shield 210 and the terminal subassembly 200 provided within the first shield 210 with respect to the insulative housing 100 in the longitudinal direction and the vertical direction (e.g., z direction shown in the figure), thereby enhancing the stability of the structure of the electrical connector 1.

In some embodiments, the first shield may comprise a first sheet that encloses a first cavity for accommodating a mating interface and at least a portion of the second shield. The second shield may comprise a second sheet that encloses a second cavity for accommodating the cable. A portion of the second shield is disposed in the first shield to form a stacked area.

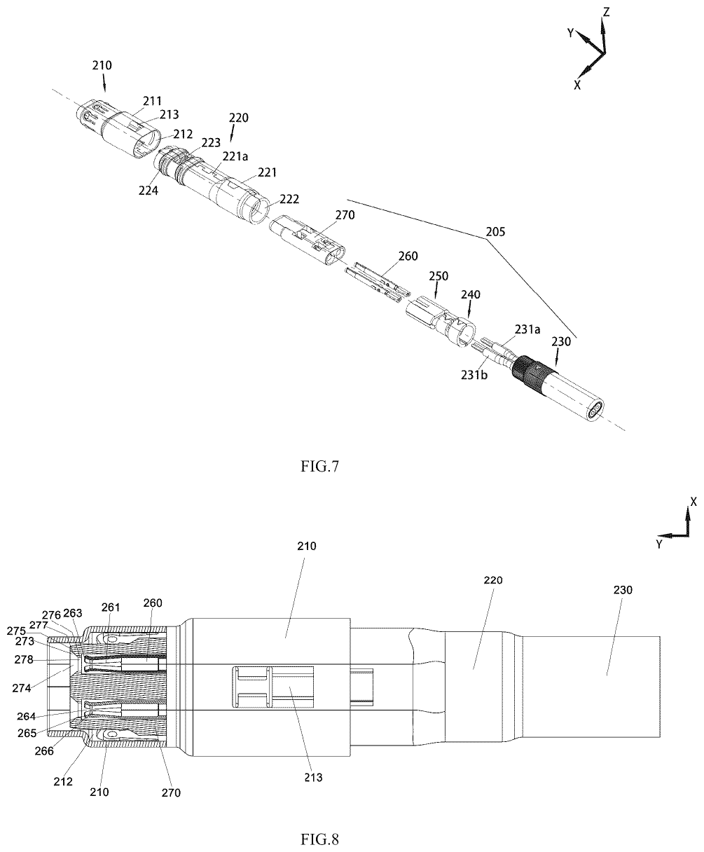

As shown in FIG. 7, the first shield 210 may be formed of a first sheet 211, and the second shield 220 may be formed of a second sheet 221. The first sheet 211 and the second sheet 221 may be formed as hollow tube. The tube may enclose the first cavity 212 and the second cavity 222. The perimeters of the first cavity 212 and the second cavity 222 may be delimited by the first sheet 211 and the second sheet 221, respectively. The first cavity 212 may accommodate a terminal 260 that is inserted into the assembly housing 270, and the accommodate housing 270 accommodates the terminal 260. The assembly housing 270 may be inserted through the second shield 220 and partially into the first cavity 212 of the first shield 210, as shown in FIG. 4.

Referring to FIG. 8, in some embodiments, the terminal 260 may be shaped, at the mating end, as a hollow cylindrical portion 261 extending in the longitudinal direction. The hollow cylindrical portion 261 of the terminal 260 may be configured with a receiving portion 263 at a mating end thereof. The hollow cylindrical portion 261 of the terminal 260 is in communication with an opening 271 at a mating end of the assembly housing 270 in the longitudinal direction via the receiving portion 263. The receiving portion 263 may be configured in a flared configuration which opens toward the opening 271 of the assembly housing 270. In some embodiments, the receiving portion 263 includes a tapering portion 265 that tapers in the longitudinal direction from the mating end of the hollow cylindrical portion 261 toward a proximal side of the hollow cylindrical portion 261. The portion of the hollow cylindrical portion 261 that forms the tapering portion 265 and that has the smallest size in a transverse cross-section perpendicular to the longitudinal direction (e.g., the x-y plane illustrated in FIG. 8) forms a neck portion of the hollow cylindrical portion 261 in the vicinity of the mating end of the hollow cylindrical portion 261. In a transverse cross-section perpendicular to the longitudinal direction (e.g., the x-y plane illustrated in FIG. 8), a size of the neck portion is smaller than a size of the body of the hollow cylindrical portion 261 near the proximal side thereof (e.g., the remaining portion of the hollow cylindrical portion 261 except for the receiving portion 263 at the mating end).

Optionally, the receiving portion 263 includes a large-diameter opening 264 located at the mating end of the hollow cylindrical portion 261, a tapering portion 265 that tapers in the longitudinal direction from the large-diameter opening 264 toward the proximal side of the hollow cylindrical portion 261, and a small-diameter opening 266 adjacent to the tapering portion 265. In the transverse cross-section perpendicular to the longitudinal direction of the electrical connector (e.g., the x-y plane illustrated in FIG. 8), the small-diameter opening 266 has a size smaller than a size of the body of the hollow cylindrical portion 261 of the terminal 260, e.g., near the proximal side thereof, such that the small-diameter opening 266 forms a neck portion of the hollow cylindrical portion 261 in the vicinity of the mating end of the hollow cylindrical portion 261. Optionally, the large-diameter opening 264 may be sized to be equal to or larger than a size of the body of the hollow cylindrical portion 261 of the terminal 260, for example, near the proximal side thereof.

In some embodiments, the receiving portion 263 may include terminals provided in pairs and spaced apart from each other. The pair of terminals may be configured to mate with a terminal of a mating connector, for example, a board connector (not shown), inserted through the opening 271 of the assembly housing 270, and the terminal may be, e.g., a signal terminal. The large-diameter opening 264 of the receiving portion 263 is configured to receive the mating terminal to be connected that is inserted through the opening 271 of the assembly housing 270. The tapering portion 265 is configured to guide the inserted mating terminals. The small-diameter opening 266 is configured to apply sufficient clamping force to the inserted mating terminal, enabling a reliable communication connection between the electrical connector 1 and a mating connector, for example board connector, according to the present disclosure.

In some embodiments according to the present disclosure, the opening 271 at a mating end of the assembly housing 270 may be configured to have a guiding portion 273. The guiding portion 273 may be in communication with an internal cavity of the assembly housing 270 for accommodating the terminal 260. The guiding portion 273 may be in communication with the receiving portion 263 at the mating end of the hollow cylindrical portion 261 of the terminal 260. The guiding portion 273 may be shaped such that: in the transverse cross-section perpendicular to the longitudinal direction of the electrical connector 1, at least a portion of the guiding portion 273 has a size smaller than a size of the mating end of the hollow cylindrical portion 261.

With continued reference to FIG. 8, in the illustrated exemplary embodiment, the guiding portion 273 may include a first portion 274 tapering in the longitudinal direction from the mating end of the assembly housing 270 toward the proximal side (e.g., toward the receiving portion 263 of the terminal 260), and a second portion 278 extending in a straight line along the longitudinal direction from the first portion 274 toward the proximal side. The second portion 278 is in communication with an internal cavity of the assembly housing 270 for accommodating the terminal 260. The second portion 278 has a size smaller than a size of the mating end of the hollow cylindrical portion 261 in a transverse cross-section perpendicular to the longitudinal direction of the electrical connector 1.

In some embodiments, the first portion 274 of the guiding portion 273 may be shaped in a funnel shape. The first portion 274 may have a large-diameter portion 275 located at a mating end of the assembly housing 270, a small-diameter portion 276 adjacent to the second portion 278, and an inclined portion 277 that extends taperingly between the large-diameter portion 275 and the small-diameter portion 276. The second portion 278 may be shaped into a cylindrical shape. As shown in FIG. 8, in a transverse cross-section perpendicular to the longitudinal direction (such as the x-y plane illustrated in the figure), a diameter of the small-diameter opening 276 may be equal to a diameter of the second portion 278, and a diameter of the second portion 278 may be smaller than a diameter of the large-diameter opening 264 of the receiving portion 263.

In some embodiments, during insertion of a mating terminal of a mating connector into the receiving portion 263 of the terminal 260, a mating terminal is guided into the receiving portion 263 under the guiding action of the guiding portion 273 of the assembly housing 270 and is electrically connected with the corresponding terminal. The opening 271 at a mating end of the assembly housing 270 of the electrical connector is configured with a guiding portion 273, and the guiding portion 273 is configured with a first portion 274 having a tapered size and a cylindrical second portion 278 that is connected to the first portion 274 and that has a reduced size. With the configuration of the second portion 278 which has a diameter smaller than a diameter of the large-diameter opening 264 of the receiving portion 263, in the process of inserting a mating terminal of a mating connector into the receiving portion 263 of the terminal 260, the inserted mating terminal may be guided firstly by the first portion 274 of the guiding portion 273 of the assembly housing 270 into the second portion 278 having a smaller size, and constrained by the reduced size of the second portion 278, the inserted mating terminal, after passing through the second portion 278, may not come into direct frontal contact with an end surface of the mating end (e.g., the large-diameter opening 264) of the receiving portion 263. Thus, the mating end of the receiving portion 263 is not subjected to folding and deformation due to compression pressure in the longitudinal direction caused by the insertion of a mating terminal of a mating connector. Accordingly, the structural reliability and performance of the subassembly of an electrical connector according to the present disclosure can be ensured, and the service life of the electrical connector can be extended. In some embodiments, under an action of the tapering portion 265 together with the small-diameter opening 266 of the receiving portion 263, it is also possible to guide and clamp the inserted mating terminal without unfavorable deformation of the mating end of the receiving portion 263. The overall stability of the mechanical connection and the electrical connection of the electrical connector structure can be improved, and the service life of the electrical connector can be extended.

It should be appreciated that the shape of the through opening 271 of the assembly housing 270 illustrated in the present disclosure is exemplary. Optionally, the guiding portion 273 may be shaped into an hourglass shape (not shown). Optionally, the second portion of the guiding portion that has a reduced size may be provided in the longitudinal direction substantially at an intermediate position between the mating end of the assembly housing and the internal cavity for accommodating the terminal, and a size of the second portion is configured to be smaller than a size of the large-diameter opening of the receiving portion. An expansion portion with an increasing size may be provided between the second portion and the internal cavity, to receive a moderate rebound deformation of the inserted mating terminal. A size of the expansion portion is provided to be smaller than a size of the mating end of the hollow cylindrical portion 261 in a transverse cross-section perpendicular to the longitudinal direction of the electrical connector 1. Optionally, a slope of the expansion portion may be configured to be smaller than a slope of the first portion to ensure that the inserted mating terminal does not come into direct frontal contact with the end surface of the mating end of the receiving portion (e.g., the large-diameter opening 264) after passing through the second portion, so as to ensure the mechanical connection and the electrical connection between the electrical connector of the present disclosure and the adapter connector.

Referring to FIG. 9, the metal sheet may have two edges joined together, the two edges being connected to each other so that the tube encloses a cavity, and in the example shown, the two edges may have one or more interlocking portions, such as one or more interlocking protrusions and recesses. In the example shown in FIG. 9, the second sheet 221 of the second shield 220 may have a protrusion 221a and a corresponding recess 221b. When the second shield 220 is formed, the protrusion 221a is fit to the recess 221b such that further mechanical integrity may be provided to the second shield 220 after the protrusion 221a and the recess 221b are interlocked. Metal sheets can be stamped, and forming metal sheets in this way may simplify the manufacturing process. It should be understood that the metal sheets may also be formed by other forming methods, such as forging.

As shown in FIG. 6, the first shield position limiting device 213 is formed as a projection 213a extending radially outward in a direction orthogonal to the outer surface of the first sheet 211. A projection 213a extends from the surface of the first sheet 211 in a direction away from the first cavity 212 to form a latching feature. In this way, the first shield position limiting device 213 may be integrally formed with the first shield 210, thereby simplifying the structure of the electrical connector 1 and reducing manufacturing costs.

Still referring to FIG. 6, the engaging portion 103 of the insulative housing 100 extends from the inner wall of the insulative housing 100 towards the cavity inside the insulative housing 100. The engaging portion 103 is aligned with the projection 213a in the longitudinal direction, and the projection 213a of the terminal subassembly 200 engages the engaging portion 103 of the insulative housing 100 when the terminal subassembly 200 is inserted into the insulative housing 100. This results in limiting the movement of the terminal subassembly 200 in the insulative housing 100 in the longitudinal direction and in the vertical direction. It should be noted that the structure of the first shield position limiting device 213 is not limited to the form of the projection 213a, and a stop pin may also be provided between the insulative housing 100 and the terminal subassembly 200 to reduce the risk of the movement of the terminal subassembly 200 in the insulative housing 100 in the vertical direction.

In some embodiments, the electrical connector may further comprise a contact carrier position assurance (CCPA) which may be inserted into the insulative housing in a direction perpendicular to the longitudinal direction of the insulative housing from outside of the insulative housing and positioned between the terminal subassembly and the insulative housing. In some embodiments, the contact carrier position assurance (CCPA) may comprise a stop device. The stop device of the contact carrier position assurance (CCPA) may extend into a cavity inside the insulative housing in a direction perpendicular to the longitudinal direction and engages the mounting end of the first shield of the terminal subassembly inserted into the insulative housing in the longitudinal direction.

Referring back to FIG. 2, the electrical connector 1 may further comprise a contact carrier position assurance (CCPA) 300. The contact carrier position assurance (CCPA) 300 may be provided with a stop device 302, which may be configured to latch the terminal subassembly 200 in the insulative housing 100. When the terminal subassembly 200 is inserted into the desired position in the insulative housing 100, the contact carrier position assurance (CCPA) 300 may be pressed to be inserted into the insulative housing 100, and the stop device 302 engages the mounting end of the first shield 210 of the terminal subassembly 200, thereby reducing the risk of the terminal subassembly 200 from moving out of the insulative housing 100. In this way, the stop device 302 prevents the terminal subassembly 200 from moving in the insulative housing 100 in the longitudinal direction, thereby enhancing the structural stability of the electrical connector 1.

As shown in FIG. 2, the contact carrier position assurance (CCPA) 300 has a base 301 extending in the longitudinal direction (y-direction) and a stop device 302 which extends in a vertical direction from an end of the base 301 close to the mounting end 101 of the insulative housing 100. In the operating state shown in FIG. 6, the contact carrier position assurance (CCPA) 300 is fully inserted into the insulative housing 100, and the stop device 302 engages the mounting end of the first shield 210 disposed on the second shield 220. Optionally, the stop device 302 engages the end of the first shield 210 close to the mounting end 101 of the insulative housing 100. In this way, the contact carrier position assurance (CCPA) 300 abuts against the side of the second shield 220 and exerts pressure to the second shield 220 to reduce the risk of movements of the terminal subassembly 200 in the longitudinal direction.

In some embodiments, the contact carrier position assurance (CCPA) may further comprise two arms extending from the base, the two arms are provided near a mating end of the base and each on two opposite sides of the base in a transverse direction perpendicular to the longitudinal direction, and the two arms extend in a vertical direction perpendicular to the longitudinal direction and the transverse direction.

Optionally, a window may be configured on two opposite side walls of the insulative housing in a transverse direction perpendicular to the longitudinal direction. Optionally, one of the windows is located on the same side wall as the beam of the insulative housing and its opening. The window of the insulative housing may be configured such that the hooked latch of the arm of the contact carrier position assurance (CCPA) is received and latched in the window after the terminal subassembly is inserted into the insulative housing.

Still referring to FIG. 2, the contact carrier position assurance (CCPA) 300 may further comprise two arms 303. The two arms 303 are provided near a mating end of the base 301 and each on two opposite sides of the base 301 in a transverse direction perpendicular to the longitudinal direction. The two arms 303 extend in a vertical direction from the two transverse ends of the base 301, in a vertical direction perpendicular to the longitudinal direction and the transverse direction. The arm 303 is spaced apart from the stop device 302. The stop device 302 is provided at a mounting end of the base 301 and extends in the vertical direction as the two arms 303.

Optionally, a bottom wall of the insulative housing 100 may be provided thereon with an opening in which the arm 303 is inserted. In the illustrated exemplary embodiment, a hooked latch 304 is provided at the end of the arm 303 of the contact carrier position assurance (CCPA) 300.

As illustrated, windows 104 is configured on two opposite side walls of the insulative housing 100, and the windows 104 may receive the hooked latch 304. The hooked latch 304 is received in the window 104 when the contact carrier position assurance (CCPA) 300 is fully inserted into the insulative housing 100. In this case, the terminal subassembly 200 is locked into the insulative housing 100. By the hooking method as described above, the contact carrier position assurance (CCPA) 300 can be fixedly disposed in the insulative housing 100, thus improving the stability of the latching action and further enabling a more stable structure of the electrical connector 1. It should be understood that the structure of the insulative housing 100 to receive the arm 303 is not limited thereto; for example, alternatively, a recess may be provided in the inner wall of the insulative housing 100 to receive the arm 303.

Optionally, on each of the opposite sides, a further window 104′ may be further provided on a side wall of the insulative housing 100, and the further window 104′ is located below the window 104, and the hooked latch 304 is received in the further window 104′ when the contact carrier position assurance (CCPA) 300 is partially inserted into the insulative housing 100. In this state, the terminal subassembly 200 can move in the insulative housing 100 in the longitudinal direction, and in this way, the position of the terminal subassembly 200 can be adjusted.

Optionally, as shown in FIG. 1, a beam 120 extending in the longitudinal direction and overhanging at the mating end may be formed on one of the two side walls of the insulative housing 100 formed with the windows 104. A first stop member 122 extending into a cavity inside the insulative housing 100 may be provided at a distal end of the beam 120, and the first stop member 122 may abut against the second shield 220 of the terminal subassembly 200 inserted into the insulative housing 100.

In some embodiments, the first shield may further comprise a stop device which may be formed on an inner surface of the first sheet, the stop device of the first shield may be disposed in a stacked area, the stop device of the first shield extends towards the first cavity in a direction orthogonal to the inner surface of the first sheet, and the second shield may further comprise a first slot configured to receive the stop device of the first shield, thereby mechanically connecting the first shield to the second shield.

Referring to FIG. 9, the first shield 210 further comprises a stop device 214 which is formed of a stop device 214a, which may be formed on the side wall of the first sheet 211. The stop device 214a may extend towards the interior of the first cavity 212. The second shield 220 may further comprise a first slot 223 which may receive the stop device 214a. In this way, the first shield 210 is mechanically connected to the second shield 220. It should be noted that the connection method of the first shield 210 to the second shield 220 is not limited thereto; Optionally, the first shield 210 may be in a thread connection to the second shield 220, and alternatively, the first shield 210 may further be in a bond connection to the second shield 220. The connection method of the present disclosure may facilitate sleeving the first shield 210 on the second shield 220, and the present disclosure may allow the overall size of the terminal subassembly 200 to be reduced by providing a stop device 214a extending into the first cavity 212 on the side wall of the first sheet 211, further reducing manufacturing costs.

It should be noted that a plurality of stops may be provided on the first shield 210 and a plurality of corresponding slots may be provided on the second shield 220. For example, in an optional embodiment of the present disclosure, the first shield 210 may further comprise a second stop device (not shown), the second stop device may be provided in a longitudinal direction in front of or behind the stop device 214a, and the second shield 220 may further comprise a second slot (not shown) parallel to the first slot 223, where the location of the second slot corresponds to the location of the second stop device. It should be understood that the second stop device and the second slot may mate the same manner as the stop device and the first slot, Optionally, the end portion of the second stop device extends through the second slot. In this way, the stability of the mechanical connection of the first shield 210 to the second shield 220 is improved.

In some embodiments, the second shield may have an oval cross section in the stacked area, the oval cross section comprises a first straight portion and a second straight portion, and a first curved portion and a second curved portion joined by the first straight portion and the second straight portion, and the second shield may comprise convexities extending radially outward from the first curved portion and the second curved portion, respectively in the stacked area and extending circumferentially.

The second shield 220 as shown in FIG. 2 may have an oval cross section 225 in the stacked area, the oval cross section 225 may comprise a first straight portion 225a, a second straight portion 225b, a first curved portion 225c, and a second curved portion 225d joined to each other, and a first slot 223 of the second shield 220 may be provided in the first straight portion 225a of the second shield 220, and the second shield 220 may further comprise a convexity 224, which may be provided on the outer surface of the second shield 220, and the convexity 224 may protrude outwardly from the first curved portion 225c and the second curved portion 225d in a direction away from the second cavity 222, as shown in FIG. 2, and the convexity 224 may be formed as a ridge extending around the second shield 220. The convexity 224 may contact the first shield 210 such that the first shield 210 is electrically connected with the second shield 220. In this way, friction force between the first shield 210 and the second shield 220 is increased, and the structural stability of the terminal subassembly 200 is further increased.

Optionally, as shown in FIG. 7, the cable 230 of the electrical connector 1 may comprise a pair of insulated conductors 231a and 231b surrounded by a cable shield, which is then covered by an insulative jacket. For termination, the insulative jacket may be removed, exposing the cable shield. This manipulation of the cable 230 enables the insulated conductors 231a and 231b to be attached to terminals of a board connector. The terminal 260 of the subassembly 205 of the terminal subassembly 200 may be crimped to the insulated conductors 231a and 231b of the cable 230, wherein the crimped end of the terminal 260 is exposed, or, the terminal 260 may be inserted into the assembly housing 270 that accommodates the terminal 260 after being crimped to the insulated conductors 231a and 231b of the cable 230, as shown in FIG. 4.

The electrical connector 1 according to an exemplary embodiment may further include a collar 240. A portion of the cable shield is exposed by removing a portion of the cable jacket, the exposed portion of the cable shield may be inserted into the collar 240, and the second shield 220 may be crimped around the collar 240 (as shown in FIGS. 4 and 7). In this way, a connection between the cable shield and the second shield 220 is formed.

Optionally, the terminal subassembly 200 may further comprise an impedance adapter 250 (as shown in FIGS. 4 and 7), which may be arranged around the cable 230. In some embodiments, the impedance adapter 250 may be a metal member and may be in electrical contact with the second shield 220. The impedance adapter 250 is closer to the insulated conductor of the cable 230 than the second shield 220, and the impedance adapter 250 substantially may cover the portion of the insulated conductor of the cable 230 in which the cable shield has been removed. The impedance adapter 250 can be spaced apart from the cable conductors to provide an impedance that matches the impedance of the conductors within the cable.

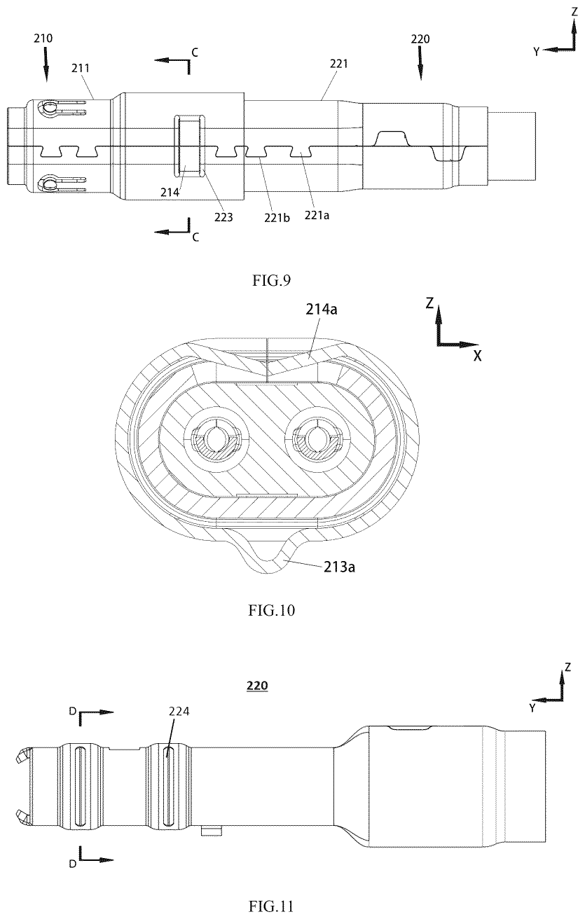

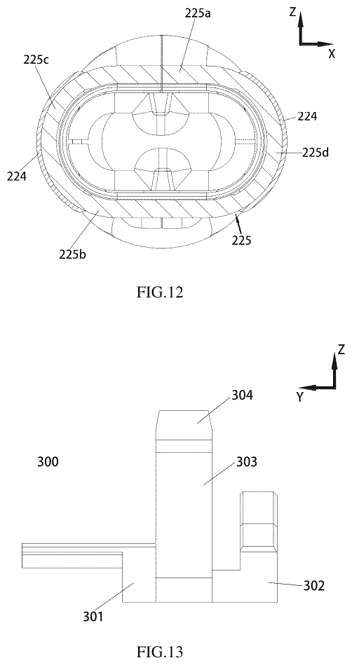

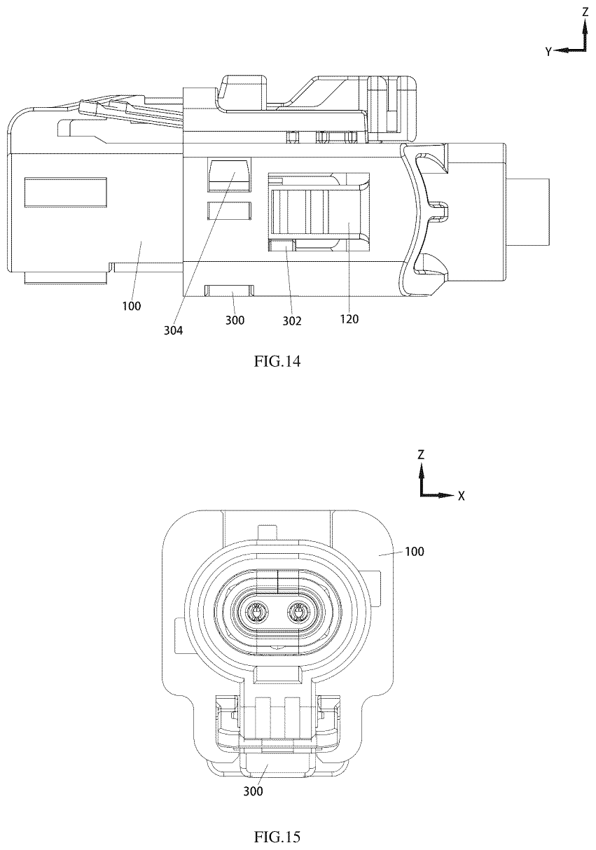

The electrical connector of the present disclosure can be applied to fields such as 5G, new energy, and environmental protection. By way of example, the electrical connector shown in FIGS. 1 to 15 of the present disclosure may be a 5G high speed connector.

Even though the present disclosure has been described with respect to a plurality of particular implementations, it is clear that the features shown or described as part of one implementation can be used with another implementation and that such variations fall within the scope of the appended claims and their equivalents. Implementations may also comprise any one of the above features or implementations, or a combination of two or more of the above features or implementations.

It should be understood by those ordinary skilled in the art relating to the present implementations that various changes in form and detail may be made without departing from the scope of the features described above. The disclosed method should be considered as descriptive only and not for the purpose of limitation. Therefore, the scope of the present disclosure shall be defined by the appended claims, and all differences within the equivalent scope of what is disclosed by the claims shall be deemed to be comprised in the scope of protection defined by the claims.

According to aspects of the present application, some embodiments relate to an electrical connector. The electrical connector may include an insulative housing and a terminal subassembly disposed in the insulative housing. The terminal subassembly may include a first shield and a second shield partially disposed in the first shield in a fixed manner. The terminal subassembly may further include thereon a position limiting device. A stop device configured to engage the position limiting device may be provided in the insulative housing. According to the technical solution described in the present application, during manufacturing the electrical connector, the risks of relative movements of the terminal subassembly in the insulative housing may be reduced by engagement between the stop device in the insulative housing and the position limiting device on the terminal subassembly, so that the terminal subassembly is fixedly disposed in the insulative housing in a detachable manner. Such a configuration can enable the electrical connector to have improved structure stability and reduced risks of loosening/unmating from a mating component due to vibration, thus providing a more consistent signal path.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Moreover, although many creative aspects have been described above with reference to the cable connector, it should be understood that the aspects of the present disclosure are not limited to these. Any one of the creative features, whether alone or combined with one or more other creative features, can also be used for other types of connectors, such as circuit board connectors. Also, the electrical connectors can be used as plug connectors or socket connectors, etc. The electrical connectors can be vertical connectors or right-angle connectors.

In the description of the present disclosure, it is to be understood that orientation or positional relationships indicated by orientation words “front’, “rear”, “upper”, “lower”, “left”, “right”, “transverse direction”, “longitudinal direction”, “vertical direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of ” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising a first opening at a mating end, a second opening at a mounting end opposite the mating end, a cavity joining the first opening and the second opening, and a beam having a distal end extending into the cavity; and
a terminal subassembly disposed in the cavity of the housing, the terminal subassembly comprising a subassembly housing, at least one terminal disposed in the subassembly housing, and first and second shields partially stacked and disposed outside the subassembly housing,
wherein the distal end of the beam of the housing engages the second shield of the terminal subassembly so as to restrain movement of the terminal subassembly toward the second opening of the housing.

2. The electrical connector of claim 1, comprising:
a contact carrier position assurance (CCPA) disposed at a bottom of the housing; and
first and second side walls of the housing disposed between a top and the bottom of the housing, wherein:
the beam extends from one of the first and second side walls of the housing into the cavity of the housing.

3. The electrical connector of claim 2, wherein:
the one of the first and second side walls of the housing comprises an opening connected to the cavity; and
the beam comprises a proximal end connected to an edge of the opening of the one of the first and second side walls.

4. The electrical connector of claim 3, wherein:
the distal end of the beam is closer to the mating end of the housing than the proximal end of the beam.

5. The electrical connector of claim 4, wherein:
the one of the first and second side walls of the housing comprises a window disposed closer to the mating end of the housing than the opening; and
the contact carrier position assurance (CCPA) comprises a base, and a first arm extending from the base and having a distal latch end engaging the window of the one of the first and second side walls of the housing.

6. The electrical connector of claim 5, wherein:
the other one of the first and second side walls of the housing comprises window; and
the contact carrier position assurance (CCPA) comprises a second arm extending from the base and having a distal latch end engaging the window of the other one of the first and second side walls of the housing.

7. The electrical connector of claim 6, wherein:
the contact carrier position assurance (CCPA) comprises a stop device extending from the base and protruding into the cavity of the housing through the bottom of the housing; and
the stop device of the CCPA abuts against an edge of the first shield of the terminal subassembly.

8. The electrical connector of claim 7, wherein:
the stop device of the CCPA has a profile conforming to a portion of a boundary of the second shield so as to engage a surface of the second shield.

9. A terminal subassembly comprising:
a subassembly housing;
at least one terminal disposed in the subassembly housing, each of the at least one terminal comprising a mating end, a mounting end opposite the mating end, and an intermediate portion joining the mating end and the mounting end;
a first shield disposed outside the subassembly housing and enclosing the mating end of the at least one terminal; and
a second shield disposed outside the subassembly housing and enclosing the mounting end of the at least one terminal, wherein:
the first shield comprises a mounting portion stacked on a mating portion of the second shield and comprising a stop device; and
the stop device of the first shield comprises two proximal ends, and a distal end disposed between the two proximal ends and protruding toward the subassembly housing through a slot of the second shield.

10. The terminal subassembly of claim 9, wherein:
the subassembly housing comprises a channel, a terminal of the at least one terminal disposed in the channel, an opening in a mating face into the channel, and a guiding portion tapering toward the mating end of the terminal disposed in the channel.

11. The terminal subassembly of claim 10, wherein:
the mating end of the terminal disposed in the channel is shaped as a funnel; and
the guiding portion of the subassembly housing overlaps with an opening of the funnel.

12. The terminal subassembly of claim 11, further comprising:
a cable attached to the mounting end of the terminal disposed in the channel.

13. The terminal subassembly of claim 9, wherein:
the first shield comprises a first sheet with a first edge and a second edge;
the first edge is joined to the second edge to at least partially encircle a first cavity with a perimeter bounded by the first sheet;
at least a part of the subassembly housing is disposed within the first cavity; and
the first sheet comprises the stop device.

14. The terminal subassembly of claim 13, wherein:
the mounting portion of the first shield further comprises a position limiting device extending away from the subassembly housing and configured to engage a housing of an electrical connector comprising the terminal subassembly.

15. An electrical connector comprising:
a housing comprising a first opening at a mating end, a second opening at a mounting end opposite the mating end, and a cavity joining the first opening and the second opening;
a terminal subassembly disposed in the cavity of the housing, the terminal subassembly comprising a subassembly housing, at least one terminal disposed in the subassembly housing, and first and second shields partially stacked and disposed outside the subassembly housing; and
a contact carrier position assurance (CCPA) comprising a base disposed at a bottom of the housing, a first arm extending from the base into the cavity to engage the housing, and a stop device extending from the base and protruding into the cavity of the housing to abut both an edge of the first shield and a surface of the second shield of the terminal subassembly.

16. The electrical connector of claim 15, wherein:
the housing comprises a first side wall having a window; and
the first arm comprises a distal latch end engaging the window of the first side wall of the housing.

17. The electrical connector of claim 16, wherein:
the first side wall of the housing comprises an opening disposed closer to the mounting end than the window; and
the housing comprises a beam disposed in the opening of the first side wall and having a proximal end connected to the first side wall and a distal end disposed closer to the mating end than the proximal end.

18. The electrical connector of claim C3, wherein:
the distal end of the beam of the housing engages the first shield of the terminal subassembly.

19. The electrical connector of claim 15, wherein:
a stacked portion of the first shield comprises a stop device protruding toward the subassembly housing through a slot of the second shield, and a position limiting device protruding away from the subassembly housing and engaging a stop device extending from a top of the housing.

20. The electrical connector of claim 19, wherein:
the stop device of the stacked portion of the first shield is on a same side as where the stop device of the CCPA abuts the edge of the first shield and the surface of the second shield.
